(19) United States
(12) Patent Application Publication
(10) Pub. No.: US 2023/0361342 A1
(43) Pub. Date: Nov. 9, 2023

(54) SOLID STATE ELECTROLYTE FOR ENERGY STORAGE DEVICES

(71) Applicant: HYZON MOTORS INC., Honeoye Falls, NY (US)

(72) Inventors: Rajesh Bashyam, Delta (CA); Sai Nitin Yellamilli, Naperville, IL (US); Zhijun Gu, Naperville, IL (US)

(21) Appl. No.: 17/966,094

(22) Filed: Oct. 14, 2022

Related U.S. Application Data
(60) Provisional application No. 63/339,247, filed on May 6, 2022.

(51) Int. Cl. H01M 10/0565; H01M 10/0525

(52) U.S. Cl. CPC H01M 10/0565; H01M 10/0525; H01M 2300/0082; H01M 2220/20

(57) ABSTRACT

Ways of making a solid-state electrolyte are provided. Various energy storage devices, such as solid-state lithium-ion batteries, can incorporate the solid-state electrolyte. The solid-state electrolyte can be manufactured by dissolving a fluoropolymer with a solvent and combining the dissolved fluoropolymer with an ionic liquid. A lithium salt can be added to the combined fluoropolymer and ionic liquid to form an electrolyte solution, which can be used to impregnate a porous membrane to provide the solid-state electrolyte.

### CROSS-REFERENCE TO RELATED APPLICATIONS

This application claims the benefit of U.S. Provisional Application No. 63/339,247, filed on May 6, 2022. The entire disclosure of the above application is incorporated herein by reference.

### FIELD

The present technology includes processes and articles of manufacture that relate to solid-state electrolytes for energy storage devices, including solid-state electrolytes for lithium-ion batteries.

### INTRODUCTION

This section provides background information related to the present disclosure which is not necessarily prior art.

Rechargeable lithium-ion batteries provide certain advantages, as lithium is the lightest and most electropositive element, which are properties that are important for high energy density. Advantages of lithium-ion batteries include a long shelf life, long cycle life, and the ability to store more energy than lead-acid, nickel-cadmium, and nickel metal hydride batteries. Certain lithium-ion batteries use organic liquid electrolytes, which may be based on alkyl carbonates. Organic liquid electrolytes can provide a wide electrochemical window, good ionic conductivity, and chemical stability. However, organic liquid electrolytes can also be volatile, flammable, and certain liquid electrolytes can produce toxic compounds (e.g., hydrofluoric acid) when exposed to water. Lithium-ion batteries having such electrolytes can therefore present issues when employed in certain conditions. The conventional polypropylene (PP) and polyethylene (PE) lithium-ion batteries separator have limited thermal stability, which will have melting induced tremendous deformation under 170° C. Deformation of separator can cause direct contact between positive and negative electrodes, resulting in an internal short circuit of cell and heat releasing from chemical reaction. Certain lithium-ion batteries can also exhibit dendritic growth of Li metal onto graphite negative electrodes, which has the potential to produce an internal short circuit. In particular, lithium dendrites can extend and can accumulate over time, pierce a separator within the battery, and cause a short circuit that can result in undesired thermal events, including battery failure. Ways to minimize lithium dendrite formation and/or growth are therefore of interest in the manufacture of lithium-ion batteries.

All solid-state batteries (ASSB) are gaining significant attention in lithium-ion battery development due to several advantages, including consistent operation, high energy density, and faster charging properties. However, certain challenges remain to be overcome, especially with respect to solid-state electrolytes (SSE), in order to improve ionic conductivity and suppress formation of lithium dendrites and manufacturing solid electrolytes at high volume. Two main approaches are being employed in development of solid electrolytes, the first being the use inorganic ceramic solid electrolytes and the second being use of a solid polymer electrolyte, where both approaches have their own advantages and disadvantages.

Accordingly, there is a need for low cost, reinforced solid polymer electrolytes that are mechanically, electrochemically, and thermally stable in a lithium polymer electrolyte for integration into various energy storage devices, such as solid-state lithium-ion batteries.

### SUMMARY

In concordance with the instant disclosure, the present technology includes articles of manufacture, systems, and processes that relate to solid polymer electrolytes that optimize mechanical, electrochemical, and thermal performance in lithium polymer electrolyte systems, and which can be integrated into energy storage devices including lithium-ion polymer batteries.

Ways of making solid-state electrolytes and batteries including such are provided that can include dissolving a fluoropolymer with a solvent. The dissolved fluoropolymer can be combined with an ionic liquid. A lithium salt can be added to the combined fluoropolymer and ionic liquid to form an electrolyte solution. The electrolyte solution can be used to impregnate a porous substrate to form a solid-state electrolyte. The solid-state electrolyte can be incorporated into an energy storage device, such as a solid-state lithium-ion battery. The solid-state lithium-ion battery can be used to power various electronic devices, including electric vehicles and hybrid electric vehicles.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a electrochemical stability windows by linear sweep voltammetry (LSV) results by measuring a Li metal/PVDF-HFP Li+ ionic liquid (IL) membrane/stainless steel coin cell embodiments of solid-state lithium-ion batteries that are constructed as: (1) a dry cell, (2) an IL as additive, and (3) a liquid electrolyte (LE) as additive.

FIG. 2 is a graphical depiction of cycle number versus specific capacity (mAh/g) for PVDF-HFP Li+IL membrane with LE cycled cell (single crystal NMC vs Li metal) cycling performance (20 μL LE drop on cathode).

FIG. 3 is a graphical depiction of specific capacity (mAh/g) versus voltage (V) for PVDF-HFP Li+IL membrane with LE cycled cell (single crystal NMC vs Li metal) voltage profiling (20 μL LE drop on cathode).

FIG. 4 is a graphical depiction of cycle number versus specific capacity (mAh/g) for PVDF-HFP Li+IL membrane with LE cycled cell (single crystal NMC vs Li metal) cycling performance (20 μL LE drop on both).

FIG. 5 is a graphical depiction of specific capacity (mAh/g) versus voltage (V) for PVDF-HFP Li+IL membrane with LE cycled cell (single crystal NMC vs Li metal) voltage profiling (20 μL LE drop on both).

FIG. 6 is a series of scanning electron microscopy images of pristine PVDF-HFP Li+IL (60 wt %) membrane with scalebar of 100 μm, 50 μm, 10 μm, 5 μm, 3 μm, and 2 μm under magnification of 400, 1k, 3k, 10k, 18k, 22k.

FIG. 7 is a graphical depiction of Zreal (Ω) versus −Zimag (Ω) for PVDF-HFP membrane full cell impedance evaluation for 20 μL liquid electrolyte (LE) on both sides (circles) and for 20 μL liquid electrolyte (LE) on cathode side (triangles).

FIG. 8 is a flowchart schematic of a method of making a solid-state electrolyte for use in an energy storage device, according to the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8, 1-3, 1-2, 2-10, 2-8,2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to low cost, reinforced solid polymer electrolytes which provide mechanically, electrochemically, and thermally stable lithium polymer electrolyte systems, and which can be integrated into energy storage devices including lithium-ion polymer batteries. The solid-state electrolyte can be incorporated into energy storage devices, such as various solid-state lithium-ion batteries. Solid-state lithium-ion batteries constructed in this manner can be used to power various electronic devices, including electric vehicles and hybrid electric vehicles.

Ways of making and using a solid-state electrolyte for use in an energy storage device can include dissolving a fluoropolymer, mixing the dissolved fluoropolymer with an ionic liquid, adding a lithium salt, and impregnating a porous substrate to thereby form the solid electrolyte.

In certain embodiments, methods of making solid-state electrolytes for use in lithium-ion batteries can include the following aspects. A fluoropolymer can be dissolved with a solvent. The dissolved fluoropolymer can be combined with an ionic liquid. An electrolyte solution can be formed by adding a lithium salt to the combined fluoropolymer and ionic liquid. A porous membrane can be impregnated with the electrolyte solution to form the solid-state electrolyte.

With respect to dissolving the fluoropolymer with a solvent, the following aspects can be included. The fluoropolymer can be dissolved by combining a powder form or pellet form of the fluoropolymer and the solvent, optionally along with some form of agitation (e.g., stirring) and/or the application of heat. For example, 10-40 wt % of fluoropolymer in solvent can be stirred at room temperature or and an elevated temperature (e.g., between 35-95 degrees Celsius) until dissolved. Various fluoropolymers and copolymers of fluoropolymers can be used, including thermoplastic fluoropolymers and thermoplastic copolymers of fluoropolymers.

The fluoropolymer can further include the following aspects. The fluoropolymer can be formed by polymerization of one or more hydrofluoroolefin monomers, including hydrofluoroethylenes, hydrofluoropropenes, hydrofluorobutenes, and hydrofluoropentenes. Where more than two types of hydrofluoroolefins are used in forming the fluoropolymer, or where a hydrofluoroolefin is used in conjunction with a hydroolefin in forming the fluoropolymer, a copolymer can be formed. As used herein, the term “copolymer” means polymers having two or more different repeating units, and the term “fluorocopolymer” means copolymers in which at least one of the repeating units is based on a monomer that is a hydrofluoroolefin. Fluorocopolymers formed by copolymerization two or more types of hydrofluoroolefin monomers, or one or more types of hydrofluoroolefin monomers and one or more types of hydroolefin monomers. Mole ratio of different hydrofluoroolefin monomers can vary from about 30:1 to about 1:30 during polymerization. Examples of hydrofluoroolefin monomers include 2,3,3,3-tetrafluoropropene, 1,3,3,3-tetrafluoropropene, including trans-1,3,3,3-tetrafluoropropene, and combinations thereof.

In certain embodiments, the fluoropolymer can include polyvinylidene fluoride, including various polyvinylidene fluoride copolymers, such as poly(vinylidene fluoride-co-hexafluoropropylene) (PVDF-HFP) copolymer. Copolymers of fluoropolymers can have various weight ratios of components, for example, where the fluoropolymer includes PVDF-HFP copolymer, the PVDF-HFP copolymer can include weight ratios of polyvinylidene fluoride (PVDF) to hexafluoropropylene (HFP), ranging from 90:10, 85:15, and 82:18.

With respect to the solvent used to dissolve the fluoropolymer, the following aspects can be included. Various solvents can be used to dissolve the fluoropolymer. Examples of solvents include ketones, among other organic solvents. Particular examples of solvents include acetone, acetonitrile, acetophenone, acrylonitrile, γ-butyrolactone, cyclohexanone, N,N-dimethylacetamide, N,N-dimethylformamide, dimethylsufoxide, 1,4-dioxane, ethyl acetate, ethyl formate, hexamethyl phosphoramide, methyl acetate, methyl ethyl ketone, N-methyl-2-pyrrolidone, propylene-1,2-carbonate, tetrahydrofuran, tetramethylurea, triethyl phosphate, trimethyl phosphate. Where the fluoropolymer includes PVDF-HFP, the solvent can be selected from those described by Bottino, A., Capannelli, G., Munari, S., & Turturro, A. (1988), Solubility Parameters of Poly(vinylidene fluoride), Journal of Polymer Science Part B: Polymer Physics, 26(4), 785-794. In certain embodiments, dissolving the fluoropolymer with the solvent includes dissolving PVDF-HFP copolymer in acetone at 40-60 degrees Celsius, and in a particular embodiment at 50 degrees Celsius.

With respect to combining the dissolved fluoropolymer with the ionic liquid (IL), the following aspects can be included. The dissolved fluoropolymer can be mixed with the ionic liquid. The dissolved fluoropolymer and ionic liquid can be mixed in various ratios, including where the ratio of (dissolved fluoropolymer):(ionic liquid) ranges from 1:1, 1:1.5, 1:2, 1:2.5, 1:3, 1:3.5, and 1:4. The ionic liquid can be a salt in the liquid state, substantially formed of ions, and can also be referred to as liquid electrolytes. The ionic liquid can include various melted salts that do not vaporize or decompose during use, as provided herein. Various types of ionic liquids can be employed, including those with organic cations, as well as those with organic cations and organic anions. The ionic liquid can have a low melting point, including a melting point at or below room temperature, and can include particular embodiments having melting points below zero degrees Celsius. Examples of the ionic liquid can include one or more of: 1-ethyl-3-methylimidazolium bis(trifluoromethylsulfonyl)imide (CAS No. 174899-82-2); N-methyl-N-propylpiperidinium bis(trifluoromethylsulfonyl)imide (CAS No. 608140-12-1); 1-ethyl-3-methylimidazolium bis(fluorosulfonyl)imide (CAS No. 235789-75-0); N-methyl-N-propylpiperidinium bis(fluorosulfonyl)imide (CAS No. 911303-46-3); 1-ethyl-3-methylimidazolium hexafluorophosphate (CAS No. 155371-19-0); N-methyl-N-propylpiperidinium hexafluorophosphate (CAS No. 1426821-81-9); and 1-butyl-3-methylimidazolium bis(trifluoromethylsulfonyl)imide (CAS No. 174899-83-3).

With respect to adding the lithium salt to the combined fluoropolymer and ionic liquid to form the electrolyte solution, the following aspects can be included. The lithium salt can be added to the combined fluoropolymer and ionic liquid solution and thoroughly mixed; e.g., stirring overnight to form a homogeneous solution. Various ratios of lithium salt to combined fluoropolymer and ionic liquid can be used to form the electrolyte solution. Examples include where the ratio of (lithium salt):(combined fluoropolymer and ionic liquid) ranges from 1:1, 1:1.5, 1:2, 1:2.5, 1:3, 1:3.5, and 1:4. Examples of lithium salts can include one or more of: LiPF₆; LiBF₄; LiBOB (lithium bisoxalato borate); LiTFSI (lithium bis(trifluorosulfonyl)imide); LiFSI (lithium fluorosulfonylimide); LiClO₄; LiAsF₆; LiSbF₆; LiSA; LiTf (lithium trifluoromethanesulfonate); LiCTFSI (lithium cyano(trifluoromethanesulfonyl)imide); LiTDI (lithium 4,5-dicyano-2-trifluoromethylimidazole); LiPDI (lithium 4,5-dicyano-2-(pentafluoroethyl) imidazolide); LiDCTA (lithium 4,5-dicyano-1,2,3-triazolate); and LiB(CN)₄.

With respect to impregnating the porous membrane with the electrolyte solution to form the solid-state electrolyte, the following aspects can be included. Various types of porous membranes can be used, including those formed of natural materials, processed natural materials, synthetic materials, and combinations thereof. The membrane is porous, in that the membrane includes a certain amount of empty space with the membrane, also referred to as the void fraction, being the fraction of the volume of voids over the total volume of the membrane. The void fraction can range from greater than 0% up to less than 100%. Certain embodiments include where the void fraction is from 25-99%, 50-99%, 75-99%, and 80-96% of the total volume of the membrane.

The porous membrane can be formed from various materials that are sintered and/or expanded to form the resulting pores in the membrane. Examples of porous membrane materials include sintered membrane materials and expanded membrane materials, including versions of polysaccharides (e.g., cellulose) and polymers, such as fluoropolymers (e.g., expanded polytetrafluoroethylene (ePTFE)) and polyolefins (e.g., polyethylene, polypropylene, etc.). In certain embodiments, the porous membrane can be formed by sintering nanoparticles and/or microparticles of one or more materials. Other embodiments include foams, including foams formed by expanding pellets of one or more materials using a blowing agent. The porous membrane can provide a dimensionally and mechanically stable lattice or framework having void space to accommodate the electrolyte solution.

The porous membrane can be impregnated with the electrolyte solution in various ways, including soaking, application of pressure or vacuum to force or draw the electrolyte solution into and substantially fill the void fraction of the porous membrane in a substantially uniform manner. The porous substrate impregnated with the electrolyte solution can be used a solid-state electrolyte in various applications, including solid-state lithium ion battery applications. In certain embodiments, the electrolyte solution is applied to the porous membrane, the electrolyte solution and porous membrane are degassed under vacuum, thereby impregnating the porous membrane with the electrolyte solution into substantially all of the void fraction of the porous membrane.

Solid-state electrolytes, and solid-state energy storage devices including such electrolytes, can be manufactured according to the present technology to provide reinforced solid polymer electrolytes that are mechanically, electrochemically, and thermally stable in a lithium polymer electrolyte. In particular, solid-state lithium-ion batteries incorporating the present solid electrolytes can provide improved performance.

### Examples

Example embodiments of the present technology are provided with reference to the several figures enclosed herewith.

The following table identifies ionic conductivities of solid-state electrolytes that include PVDF-HFP-IL membranes constructed in accordance with the present technology.

| Solid-State Electrolyte (SSE) Sample | Ionic Conductivity (S/cm) |
|---|---|
| 40 wt % LiTFSI in PVDF-HFP and IL | 6.58 × 10⁻⁴ |
| 40 wt % LiTFSI in PVDF-HFP and IL | 7 × 10⁻⁴ |
| 60 wt % LiTFSI in PVDF-HFP and IL | 7.5 × 10⁻⁴ |

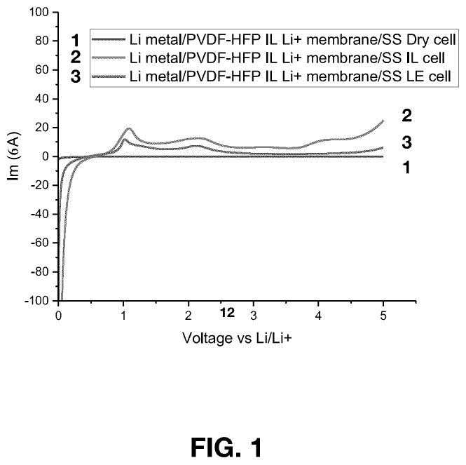

With reference to FIGS. 1-8, properties of lithium ion batteries incorporating solid-state electrolytes constructed in accordance with the present technology are shown.

FIG. 1 graphically depicts electrochemical stability windows by linear sweep voltammetry (LSV) results by measuring Li metal/PVDF-HFP Li+ ionic liquid (IL) membrane/stainless steel coin cell embodiments of solid-state lithium-ion batteries that are constructed as: (1) a dry cell, (2) an IL as additive, and (3) a liquid electrolyte (LE) as additive.

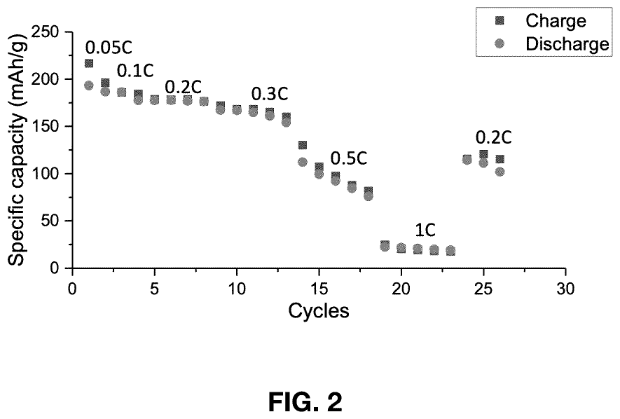

FIG. 2 is a graphical depiction of cycle number versus specific capacity (mAh/g) for PVDF-HFP Li+IL membrane with LE cycled cell (single crystal NMC vs Li metal) cycling performance (20 μL LE drop on cathode), with squares depicting a charge state and circles depicting a discharge state.

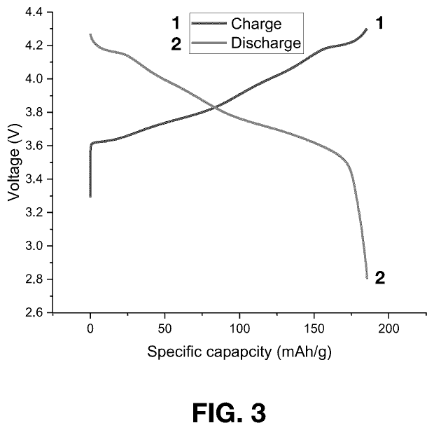

FIG. 3 is a graphical depiction of specific capacity (mAh/g) versus voltage (V) for PVDF-HFP Li+IL membrane with LE cycled cell (single crystal NMC vs Li metal) voltage profiling (20 μL LE drop on cathode), with (1) depicting a charge state and (2) depicting a discharge state.

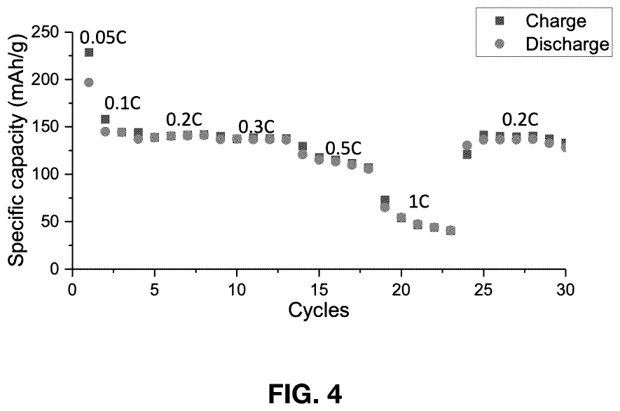

FIG. 4 is a graphical depiction of cycle number versus specific capacity (mAh/g) for PVDF-HFP Li+IL membrane with LE cycled cell (single crystal NMC vs Li metal) cycling performance (20 μL LE drop on both), with squares depicting a charge state and circles depicting a discharge state.

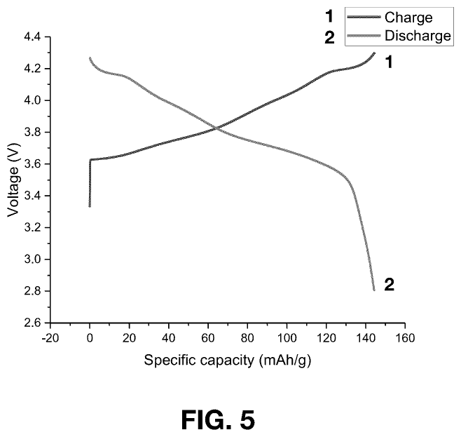

FIG. 5 is a graphical depiction of specific capacity (mAh/g) versus voltage (V) for PVDF-HFP Li+IL membrane with LE cycled cell (single crystal NMC vs Li metal) voltage profiling (20 μL LE drop on both), with (1) depicting a charge state and (2) depicting a discharge state.

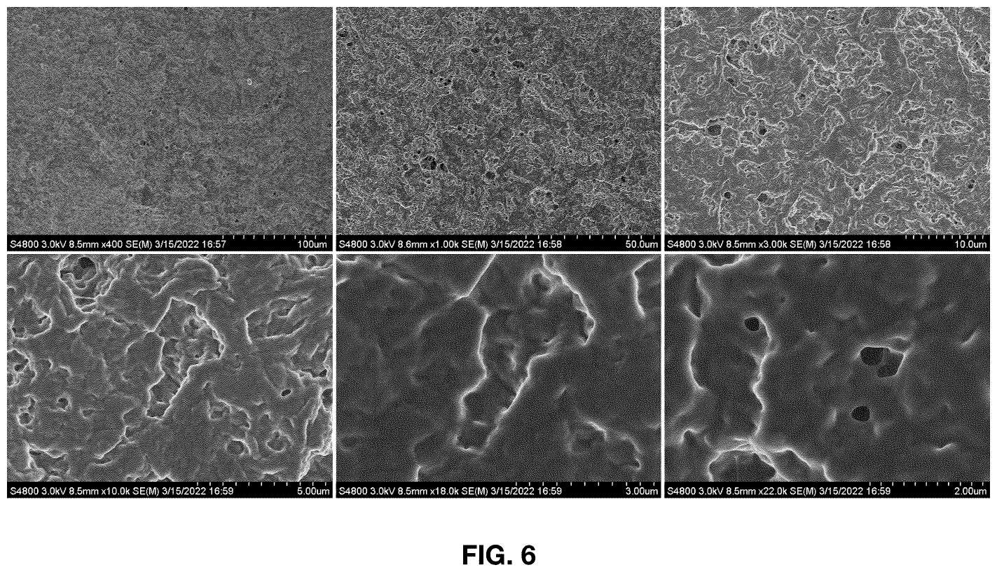

FIG. 6 is a series of scanning electron microscopy images of pristine PVDF-HFP Li+IL (60 wt %) membrane with scalebars of (top row, left to right) 100 μm, 50 μm, 10 μm, (bottom row, left to right) 5 μm, 3 μm, and 2 μm, under magnification of 400, 1k, 3k, 10k, 18k, 22k, respectively.

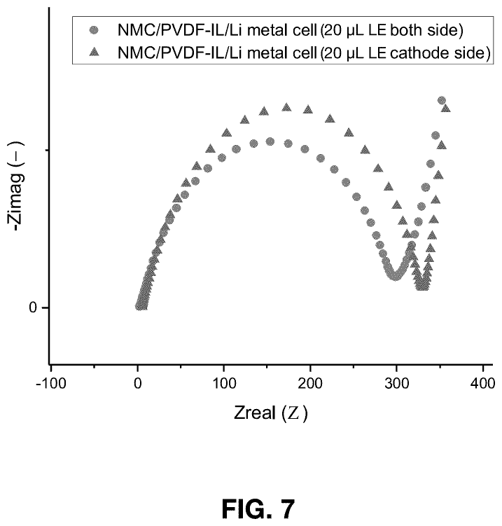

FIG. 7 is a graphical depiction of Zreal (Ω) versus −Zimag (Ω) for PVDF-HFP membrane full cell impedance evaluation for 20 μL liquid electrolyte (LE) on both anode and cathode sides (circles) and for 20 μL liquid electrolyte (LE) on only the cathode side (triangles).

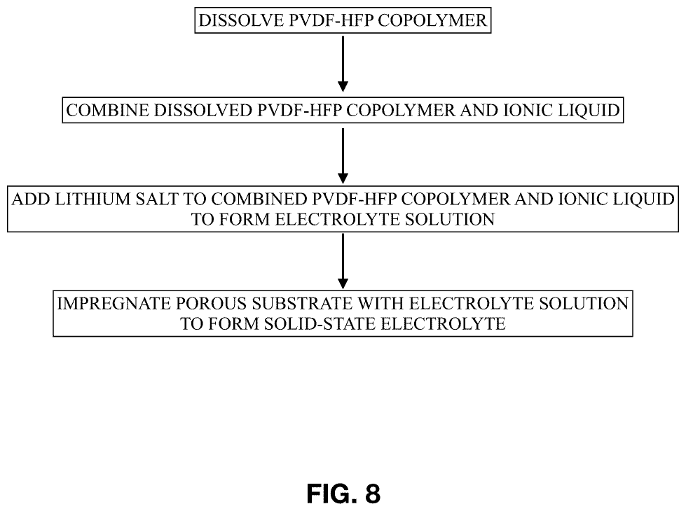

FIG. 8 is a flowchart schematic of a method of making a solid-state electrolyte for use in an energy storage device, according to the present technology.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of making a solid-state electrolyte, comprising:
dissolving a fluoropolymer with a solvent;
combining the dissolved fluoropolymer with an ionic liquid;
adding a lithium salt to the combined fluoropolymer and ionic liquid to form an electrolyte solution; and
impregnating a porous membrane with the electrolyte solution to thereby form the solid-state electrolyte.

2. The method of claim 1, wherein the fluoropolymer includes polyvinylidene fluoride.

3. The method of claim 1, wherein the fluoropolymer includes a polyvinylidene fluoride copolymer.

4. The method of claim 1, wherein the fluoropolymer includes poly(vinylidene fluoride-co-hexafluoropropylene).

5. The method of claim 1, wherein the solvent includes a ketone.

6. The method of claim 1, wherein the solvent includes acetone.

7. The method of claim 1, wherein dissolving the fluoropolymer with the solvent includes dissolving poly(vinylidene fluoride-co-hexafluoropropylene) in acetone at 40-60 degrees Celsius.

8. The method of claim 1, wherein the ionic liquid includes an organic cation and an organic anion.

9. The method of claim 1, wherein the ionic liquid includes a member selected from a group consisting of: 1-ethyl-3-methylimidazolium bis(trifluoromethylsulfonyl)imide; N-methyl-N-propylpiperidinium bis(trifluoromethylsulfonyl)imide; 1-ethyl-3-methylimidazolium bis(fluorosulfonyl)imide; N-methyl-N-propylpiperidinium bis(fluorosulfonyl)imide; 1-ethyl-3-methylimidazolium hexafluorophosphate; N-methyl-N-propylpiperidinium hexafluorophosphate; and 1-butyl-3-methylimidazolium bis(trifluoromethylsulfonyl)imide (CAS No. 174899-83-3).

10. The method of claim 1, wherein the lithium salt includes a member selected from a group consisting of: LiPF₆; LiBF₄; LiBOB (lithium bisoxalato borate); LiTFSI (lithium bis(trifluorosulfonyl)imide); LiFSI (lithium fluorosulfonylimide); LiClO₄; LiAsF₆; LiSbF₆; LiSA; LiTf (lithium trifluoromethanesulfonate); LiCTFSI (lithium cyano(trifluoromethanesulfonyl)imide); LiTDI (lithium 4,5-dicyano-2-trifluoromethylimidazole); LiPDI (lithium 4,5-dicyano-2-(pentafluoroethyl) imidazolide); LiDCTA (lithium 4,5-dicyano-1,2,3-triazolate); and LiB(CN)₄.

11. The method of claim 1, wherein the lithium salt includes LiFSI (lithium fluorosulfonylimide).

12. The method of claim 1, wherein the porous membrane includes a member selected from a group consisting of: a polysaccharide; a fluoropolymer; and a polyolefin.

13. The method of claim 1, wherein the porous membrane is formed by sintering.

14. The method of claim 1, wherein the porous membrane is formed by expansion.

15. A solid-state electrolyte made according to the method of claim 1.

16. A solid-state lithium-ion battery comprising a solid-state electrolyte made according to the method of claim 1.

17. A method of making a solid-state electrolyte, comprising:
dissolving a fluoropolymer with a solvent;
combining the dissolved fluoropolymer with an ionic liquid;
adding a lithium salt to the combined fluoropolymer and ionic liquid to form an electrolyte solution; and
impregnating a porous membrane with the electrolyte solution to thereby form the solid-state electrolyte;
wherein:
the fluoropolymer includes a polyvinylidene fluoride copolymer;
the solvent includes a ketone;
the ionic liquid includes an organic cation and an organic anion; and
the porous membrane includes a member selected from a group consisting of: a polysaccharide; a fluoropolymer; and a polyolefin.

18. A solid-state electrolyte made according to the method of claim 17.

19. A solid-state lithium-ion battery comprising a solid-state electrolyte made according to the method of claim 17.

20. A vehicle comprising a solid-state lithium-ion battery having a solid-state electrolyte made according to the method of claim 17.
